(19) United States
(12) Patent Application Publication
(10) Pub. No.: US 2013/0198595 A1
(43) Pub. Date: Aug. 1, 2013

(54) DYNAMIC FORM CONTROL

(71) Applicants: Larry Waldman, Seattle, WA (US); Dan Battagin, Bellevue, WA (US); Shahar Prish, Redmond, WA (US); Eran Megiddo, Bellevue, WA (US)

(72) Inventors: Larry Waldman, Seattle, WA (US); Dan Battagin, Bellevue, WA (US); Shahar Prish, Redmond, WA (US); Eran Megiddo, Bellevue, WA (US)

(73) Assignee: Microsoft Corporation, Redmond, WA (US)

(21) Appl. No.: 13/359,322

(22) Filed: Jan. 26, 2012

(51) Int. Cl. G06F 17/00

(52) U.S. Cl. 715/205

(57) ABSTRACT

Disclosed herein are systems, methods, and software that provide for dynamic form control. Aspects pertain to forms derived from base forms associated with content targets. User input is received into the forms, such as input data or object selections, as well as other types of user input. Control information within the content targets is identified and, in response to the user input, the forms are controlled based on the control information.

### TECHNICAL FIELD

Aspects of the disclosure are related to computer hardware and software, and in particular, to dynamically controlling forms.

### TECHNICAL BACKGROUND

In the field of computer hardware and software, productivity applications are used to produce content, such as spreadsheets and documents. Forms are mechanisms with which users may submit data to and interact with the content. In a common example, forms simplify data entry processes, such as entering values into a spreadsheet. Data can be entered into fields within a form, and then submitted into corresponding parts of a spreadsheet.

Initially, forms were deployed within the content to which the forms were linked. For example, a form for entering inventory data into a spreadsheet would reside in the same spreadsheet. Eventually forms were decoupled from the underlying content and can now be published in a wide variety of ways, allowing many users to interact remotely with the underlying content using email clients, web browser applications, and other applications.

For example, a user may distribute an invitation to an event via email to a number of recipients, with a link to a form included in the email. Each recipient can access the form and respond to the invitation simply by clicking on the link. Responses provided by the recipients, such as their intention to attend the event, can be returned and entered into a spreadsheet via the form.

Unfortunately, forms remain relatively static relative to the dynamic capabilities of the underlying content to which they are linked. Data validation is one such capability that allows users to define valid formats, ranges, and other specifications for data entered directly into a spreadsheet or table.

### OVERVIEW

Disclosed herein are systems, methods, and software that provide for dynamic form control and behavior. Aspects include utilizing productivity applications to generate base forms associated with content targets. Users can enter data into the content targets via user forms that are rendered from the base forms. The user forms include user components that correspond to base components within the base forms. The user forms can be dynamically controlled based on events corresponding to the user components. For example, dynamic control over data validation, form population, and form augmentation are provided.

This Overview is provided to introduce a selection of concepts in a simplified fashion that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a process for providing dynamically controlled forms.

FIG. 2 illustrates a dynamic form environment.

FIG. 3 illustrates a dynamic form system.

FIG. 4 illustrates a dynamic form environment.

FIG. 5 illustrates operations within a dynamic form environment.

FIG. 6 illustrates a computer system suitable to a dynamic form environment.

FIGS. 7-9 illustrate operational sequences in a dynamic form environment.

FIG. 10-11 illustrate detailed views of a dynamic form environment.

### TECHNICAL DISCLOSURE

Implementations described herein provide for generating and deploying dynamic forms. In particular, base forms can be generated with productivity applications. For instance, a user may operate a spreadsheet application to generate a base form associated with a spreadsheet. The base form may be created to include a number of base components, such as data entry components, graphics components, and the like. In one implementation, a base component may allow for the inclusion of executable code within the form, or a link to executable code, that can augment the presentation of user forms derived from the base form.

User forms derived from the base form can be rendered externally to the productivity application and may include a number of user components corresponding to the base components. The user forms are dynamically controlled based on events which occur with respect to the user components. For example, some user components may periodically augment the display of the user forms. In other examples, control over the user forms may be based on user interaction or input with the user components.

In a brief example, an event organizer may distribute an invitation to an event via email to a number of recipients, with a link to a base form included in the email. By clicking on the clink, a user form can be derived from the base form for each user, into which each user may enter data into fields or make selections via control objects contained in the user form. The user input is provided to an underlying spreadsheet associated with the base form, or a portion of a spreadsheet such as a table, and entered therein for review by the event organizer.

Dynamic control can be provided over the user form in a variety of ways, such as by enforcing data validation against data input by the recipients, defining values or ranges with which the control objects may be populated, or dynamically running scripts or other types of program modules. Moreover, such dynamic control may be based on control information within the underlying spreadsheet. In other words, control over the various forms derived from the base form associated with the underlying spreadsheet may be provided by way of interacting with the spreadsheet itself.

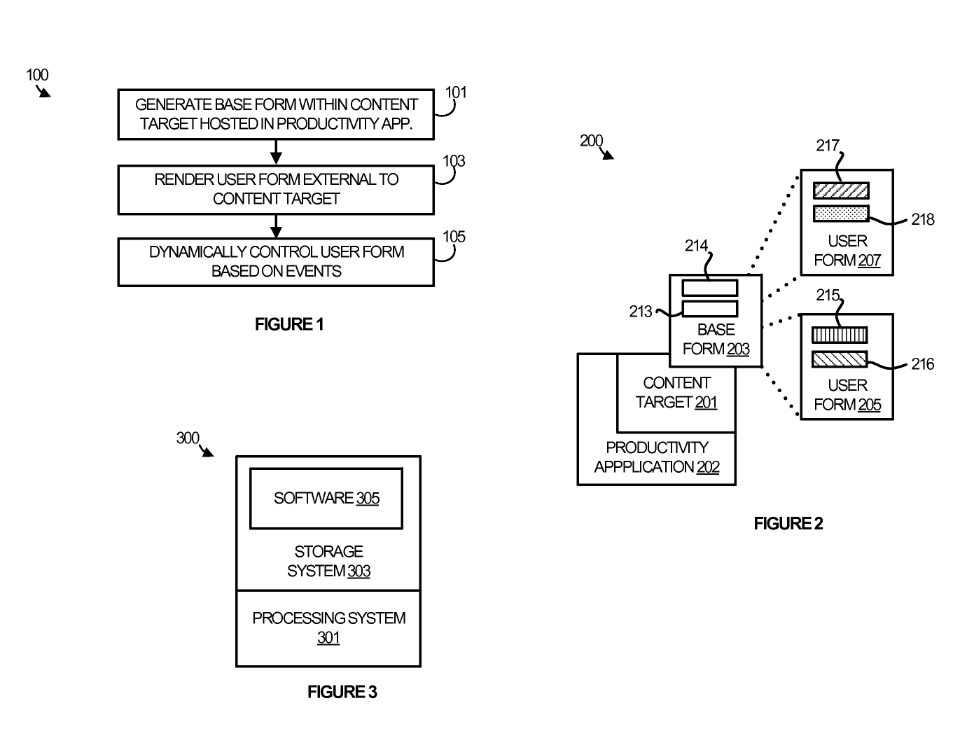

FIGS. 1-3 are provided to illustrate one implementation for providing dynamic forms. In particular, FIG. 1 illustrates process 100 for providing dynamic forms, while FIG. 2 illustrates a dynamic form environment 200 in which process 100 may be implemented. FIG. 3 provides an exemplary dynamic form system 300 for employing process 100.

The following discussion of FIG. 1 is made with reference to the elements of dynamic form environment 200 for purposes of clarity, although it should be understood that process 100 is applicable to a wide variety of environments and is not limited to the environment shown in FIG. 2.

Dynamic form environment 200 includes content target 201, base form 203, user form 205, and user form 207. Content target 201 is hosted within productivity application 202 and may be any content capable of receiving user input via user forms 205 and 207. Examples of content target 201 include spreadsheets, documents, and presentations. Examples of productivity application 202 include spreadsheet applications, document editors, and presentation applications, such as the Microsoft® Excel®, Word, and PowerPoint® applications, as well as the Google Docs suite of applications. User forms 205 and 207 are derived from base form 203. Base form 203 may be integrated with content target 201, but may be a separate data structure. In either case, base form 203 is considered to be associated with content target 201 since user forms derived from base form 203 are linked to content target 201.

Content target 201 and base form 203 are generated using productivity application 202. Productivity application 202 may be implemented as an independent application, but may also be provided within an integrated application environment, such as within a browser application Likewise, user forms 205 and 207 may be provided as standalone forms, but may also be provided within other applications, such as an email application, a web browsing application, a spreadsheet application, a document editor, a mobile application, or any other application capable of rendering forms. It should be understood that any of the aforementioned applications capable of rendering forms may be employed on a wide variety of devices, such as personal computers, laptop or tablet computers, mobile computing devices, client or server devices, internet appliances, and any other type of computing device.

Referring now to process 100, base form 203 is generated with content target 201 hosted by productivity application 202 (step 101). This may be accomplished using a form generator, such as form editor provided within productivity application 202, a form wizard, or some other tool allowing a developer to generate base form 203. Base form 203 includes base components 213 and 214. Base components 213 and 214 are provided for data entry purposes to allow for data entry into content target 201. Examples of base components 213 and 214 include data entry objects, drop down menus, radio buttons, as well as other well-known components generally deployed within forms.

Next, user forms 205 and 207 are rendered from base form 203 by way of various applications capable of rendering forms (step 103). For example, base form 203 or links to it may be distributed such that various users can enter data into content target 201 by way of user forms 205 and 207. The applications utilized by the users, such as email applications or web browsing applications, process base form 203 to instantiate user forms 205 and 207. User forms 205 and 207 are rendered with user components 215 and 216 and user components 217 and 218 corresponding to base components 213 and 214 found in base form 203.

Finally, user forms 205 and 207 are dynamically controlled based on the occurrence of events with respect to user components 215 and 216 and user components 217 and 218 (step 105). For example, some user components may periodically be activated to augment the display of user forms 205 and 207. In other examples, control over user forms 205 and 207 may be based on user input. In fact, FIG. 2 illustrates each of user components 215 and 216 and user components 217 and 218 using different fill characteristics to demonstrate that each component may behave differently than the others, or otherwise be dynamically controlled based on the occurrence of events related to each component.

Referring now FIG. 3, dynamic form system 300 and the associated discussion are intended to provide a brief, general description of a suitable computing environment in which process 100 may be implemented. Many other configurations of computing devices and software computing systems may be employed to implement a system for dynamically controlling forms.

Dynamic form system 300 may be any type of computing system capable of providing dynamically controlled forms, such as a desktop computer, laptop computer, notepad computer, tablet computer, server computer, client computer, mobile computing device, internet appliance, or any combination or variation thereof. Indeed, dynamic form system 300 may be implemented as a single computing system, but may also be implemented in a distributed manner across multiple computing systems. For example, dynamic form system 300 may be representative of a computer on which user form 205 is rendered, a computer on which user form 207 is rendered, and a computer on which content target 201 may be hosted and productivity application 202 executed. Indeed, dynamic form system 300 is provided as an example of a general purpose computing system that, when implementing process 100 in either a distributed or non-distributed manner, becomes a specialized system capable of providing dynamically controlled forms.

Dynamic form system 300 includes processing system 301, storage system 303, and software 305. Processing system 301 is communicatively coupled with storage system 303. Storage system 303 stores software 305 which, when executed by processing system 301, directs dynamic form system 300 to operate as described for process 100 in dynamic form environment 200.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include a general purpose central processing unit, application specific processors, and graphics processors, as well as any other type of processing device.

Storage system 303 may comprise any storage media readable by processing system 301 and capable of storing software 305. Storage system 303 may include volatile and nonvolatile, removable and non-removable media implemented in any method or technology for storage of information, such as computer readable instructions, data structures, program modules, or other data. Storage system 303 may be implemented as a single storage device but may also be implemented across multiple storage devices or sub-systems. Storage system 303 may comprise additional elements, such as a controller, capable of communicating with processing system 301.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 305 comprises computer program instructions, firmware, or some other form of machine-readable processing instructions having process 100 embodied therein. Software 305 may be implemented as a single application but also as multiple applications. Software 305 may be a stand-alone application but may also be implemented within other applications distributed on multiple devices, including but not limited to productivity application software and operating system software.

In general, software 305 may, when loaded into processing system 301 and executed, transform processing system 301, and dynamic form system 300 overall, from a general-purpose computing system into a special-purpose computing system customized to dynamically control forms as described by process 100 and its associated discussion.

Encoding software 305 may also transform the physical structure of storage system 303. The specific transformation of the physical structure may depend on various factors in different implementations of this description. Examples of such factors may include, but are not limited to: the technology used to implement the storage media of storage system 303, whether the computer-storage media are characterized as primary or secondary storage, and the like.

For example, if the computer-storage media are implemented as semiconductor-based memory, software 305 may transform the physical state of the semiconductor memory when the software is encoded therein. For example, software 305 may transform the state of transistors, capacitors, or other discrete circuit elements constituting the semiconductor memory.

A similar transformation may occur with respect to magnetic or optical media. Other transformations of physical media are possible without departing from the scope of the present description, with the foregoing examples provided only to facilitate this discussion.

Referring again to FIGS. 1-3, through the operation of dynamic form system 300 employing software 305, transformations are performed on user form 205 and user form 207. As an example, user form 205 or user form 207 could be considered transformed from one state to another by the application of formatting requirements to input data, by populating a control object with data supplied by control information, or by calling a program module that augments the display of user form 205 and 207. Dynamic form system 300 may have additional devices, features, or functionality. Dynamic form system 300 may optionally have input devices such as a keyboard, a mouse, a voice input device, or a touch input device, and comparable input devices. Output devices such as a display, speakers, printer, and other types of output devices may also be included. Dynamic form system 300 may also contain communication connections and devices that allow dynamic form system 300 to communicate with other devices, such as over a wired or wireless network in a distributed computing and communication environment. These devices are well known in the art and need not be discussed at length here.

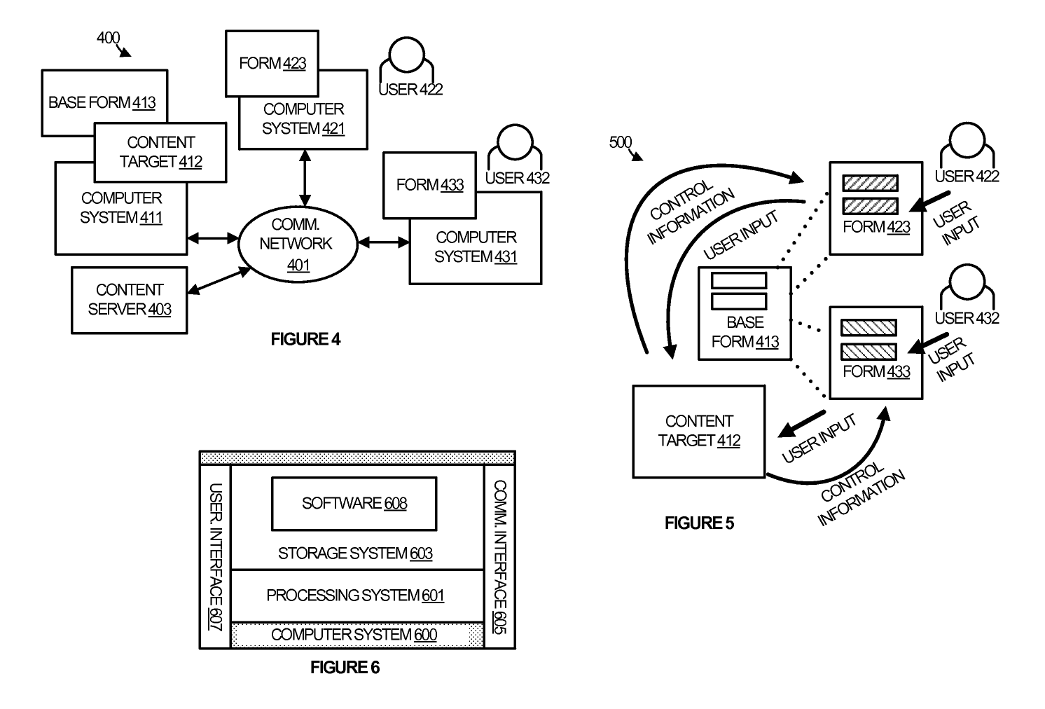

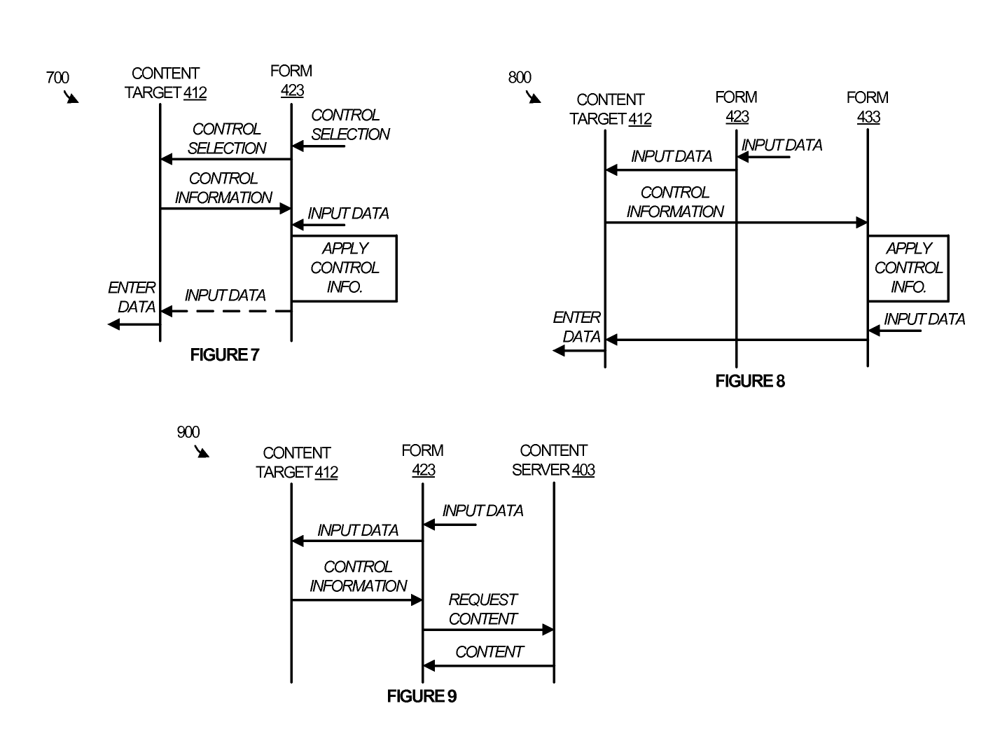

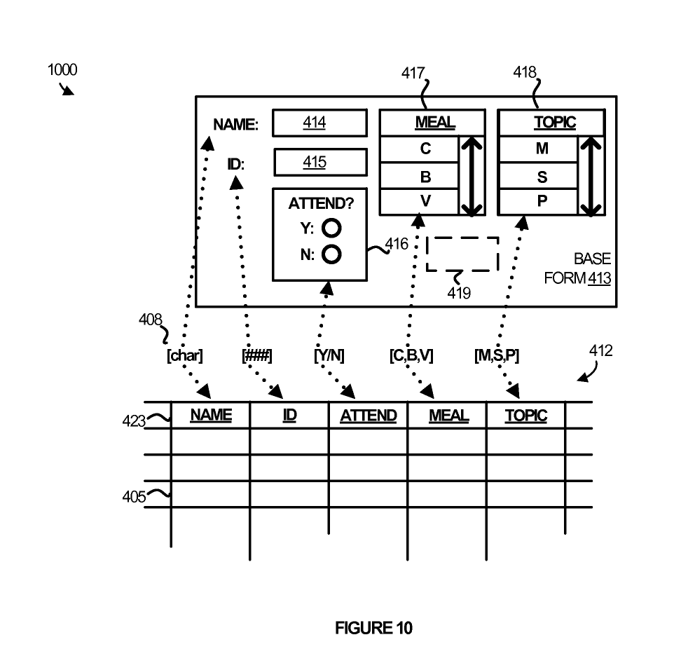

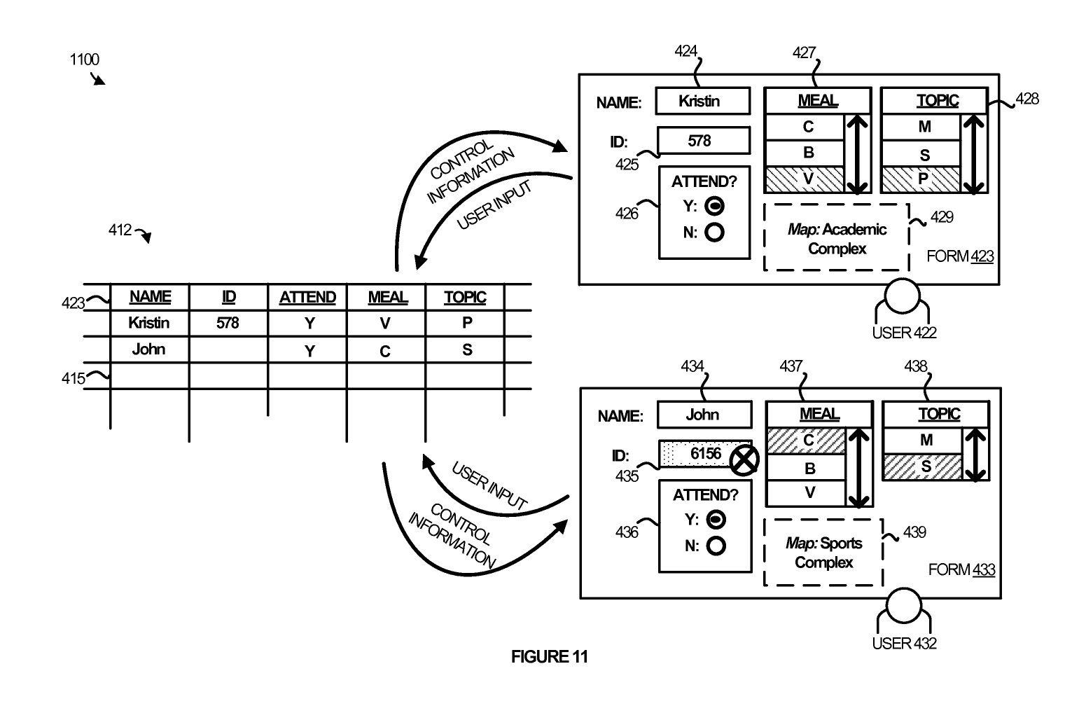

Turning now to FIGS. 4-11, disclosed is an implementation of a dynamic form environment 400 in FIG. 4, while FIG. 5 describes the operation of dynamic form environment 400. FIG. 6 describes a suitable computer system 600 for implementing any of the computer systems included in dynamic form environment 400. FIGS. 7-9 illustrate several operational sequences involving the elements of dynamic form environment 400. FIG. 10 illustrates a detailed view of dynamic form environment 400 allowing a user to develop a base form, while FIG. 11 illustrates a detailed view of the implementation of the base form developed in FIG. 10.

The environments, operational sequences, and views provided in FIGS. 4-11 are representative of exemplary architectures and methodologies for performing novel aspects of the disclosure. While, for purposes of simplicity of explanation, the methodologies included herein may be in the form of a functional diagram, operational sequence, or detailed view, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

Referring to FIG. 4, dynamic form environment 400 includes communication network 401 over which content server 403 and computer system 411 communicate with computer system 421 and computer system 431. Computer system 411, computer system 421, and computer system 431 may be implemented using any suitable computing technology, such as computer system 600 described in more detail below with respect to FIG. 6. Communication network 401 may be any network or collections of networks over which content server 403 and computer system 411 may communicate with computer system 421 and computer system 431.

Content target 412 resides on computer system 411 and may be implemented by way of a productivity application running on computer system 411. Base form 413 is associated with content target 412. Content target 412 may comprise any data structure suitable for hosting within the productivity application and generating base forms. Examples of content target 412 include spreadsheets, documents, presentations, and the like.

Form 423 and form 433 reside on computer system 421 and computer system 431 respectively. Form 423 and form 433 may be any forms derived from base form 413 and through which content target 412 may be accessed. Form 423 and form 433 may be rendered by any type of application, such as an email application, a web browsing application, or some other type of program application capable of running on computer systems 411, 421, and 431. Base form 413 may be considered to be associated with content target 412 since forms 423 and form 433, derived from base form 413, are linked to content target 412. Base form 413 may be a data structure contained within content target 412. Alternatively, base form 413 may be a data structure separate from content target 412.

FIG. 5 is provided to illustrate the operation of dynamic form environment 400 in one implementation whereby forms are used to submit data to a content target, such as a spreadsheet. In this implementation, forms 423 and 433 have been rendered from base form 413. User interacts with form 423 to fill it out, while user 432 interacts with form 433. The data provided by users 422 and 423 into forms 423 and 433 can be submitted to content target 412. Referring to FIG. 5, user input is received from user 422 in form 423. The user input may be an input of data into form 423, a selection of a control object within form 423, or a selection of data within form 423, as well as any other type of user input, combination of inputs, or variations thereof. For example, user 422 may perform a hover operation over an element or portion of form 423. In another example, user 422 may select an input object into which user 422 intends to input data or otherwise indicate data to enter into content target 412.

Next, control information within content target 412 is identified. The control information may be any type of information with which form 423 can be controlled. For example, the control information may indicate a format for data input into form 423. Alternatively, the control information may indicate data with which to populate a control objected selected within form 423. The control information may be provided to form 423 in a number of ways. For example, form 423 may communicate with content target 412 to obtain the control information. However, form 423 may also communicate with base form 413 to obtain the control information. This his case, content target 412 may first provide the control information to base form 413, which in turn would provide the control information to form 423.

It should be understood that other operations may occur in response to the user input. For instance, the user input may trigger the execution of code embedded within or linked from form 423 that augments the display or presentation of form 423. Such an operation could also be triggered by some other event relating to form 423. Optionally, the control information returned by content target 412 may direct form 423 to execute the code, or otherwise trigger a call that results in an augmentation of form 423.

Upon identifying the control information, the response by form 423 to the user input is controlled accordingly. In some situations, the format of data input via the user input may be checked against the format specified in the control information. In other situations the data from which user 422 may make a selection is determined based on a group of data provided in the control information. In a situation where a program module is called, form 423 may be augmented. For instance, the program module may activate a graphic within form 423 or retrieve supplement information or images from an external content source to display within form 423. The program module may also perform relatively simple operations, such as animating portions of form 423.

It should be understood that similar operations may apply with respect to form 433, in addition to form 423. For instance, user 432 may provide user input to form 433, in response to which control information within content target 412 is identified. Then, form 433 is controlled accordingly in response to the user input based on the control information.

Controlling form 433 may be similar to that described with respect to form 423, such as validating input data, populating control objects, or calling program modules. However, controlling form 433 may also involve modifying form 433 based on the user input provided by user 422 in form 423. For example, user 422 may provide a user input that drives a change to form 433. Likewise, user input provided by user 432 with respect to form 433 may factor into the control of form 423. A more detailed discussion of the various ways in which a form may be dynamically controlled is provided with respect to FIGS. 7-10.

FIG. 7 illustrates operational sequence 700 pertaining to an implementation whereby form 423 is dynamically controlled using control information within content target 412. In this implementation, user 422 makes a control selection via form 423. For example, user 422 may select a control object within form 423 into which data can be entered. The control selection is communicated from form 423 to content target 412. Content target 412 responsively returns control information to form 423 related to the control selection made by user 422. The control information may indicate a number of things, including a proper format for data entered into the control object or an allowed range of data, as well as other types of control information.

Upon obtaining the control information, form 423 receives input data provided by user 422 and applies the control information to the input data. For instance, the input data may be validated against the proper format or the allowed range of data indicated by the control information. Assuming the input data is valid, the input data is communicated from form 423 to content target 412, into which the input data is entered and stored. However, if the input data is not valid, an indication of the rejection of the input data may be provided to user 422. Optionally, a recommendation may be provided to user 422 that describes the proper format for input data.

FIG. 8 illustrates operational sequence 800 pertaining to an implementation whereby input data received into form 423 results in providing control information to form 433. As illustrated, user 422 inputs data into form 423, which is communicated to content target 412. Content target 412 identifies control information associated with the user input, but may also identify other forms impacted by the user input.

In this example, content target 412 communicates the control information to form 433. The control information is applied with respect to form 433 to control the display or behavior of form 433. For example, the control information may indicate a change to a range of values that may be provided by way of a control object in form 433. Alternatively, the control information may indicate a change to a group of data selectable by way of a control object in form 433. User 432 provides a user input, such as input data, into form 433 in view of the potential modifications made to form 433 based on the control information. The input data is communicated for entry into and storage in content target 412.

FIG. 9 illustrates operational sequence 900 pertaining to an implementation whereby content server 403 provides content to form 423. In this implementation, user 422 provides a user input, such as input data, in form 423. The input data is communicated to content target 412. Content target 412 responsively identifies control information based on the input data. For instance, certain values or strings indicated by the input data may be associated with particular control information.

The control information is communicated to form 423, the control of which is based on the control information. In this example, the control information identifies a program module within form 423. Form 423 responsively calls the program module, which once called, requests content from content server 403. Content server 403 provides the content to form 423, which displays the content to user 422. For instance, information, images, or other types of content may be supplied to augment the display of form 423.

It should be understood that executing the program module may occur independently from or irrespective of control information provided by content target 412. Rather, as discussed above, form 423 may include executable code or other such program modules or links to external sources of code for augmenting form 423. The code may run in response to any number of factors, such as periodic timers, events defined by user inputs, and other types of triggers.

Turning now to FIG. 10, detailed view 1000 of dynamic form environment 400 provides an illustration of development of a base form. FIG. 11 then presents detailed view 1100 illustrating the deployment of the base form developed in FIG. 10. View 1000 is provided within an exemplary context involving generation of a form pertaining to an event, such as conference or a convention, and responses corresponding to the planned participation of invitees to the event. This may be accomplished using a form development tool, such as a form editor found within a spreadsheet application, a form wizard, or other similar development tools.

View 1000 includes content target 412 and base form 413. In this example, content target 412 comprises a spreadsheet having cells 405 into which data can be entered via form 423 and form 433. The cells are defined by rows and columns, with the top most row of cells containing labels of identifiers that describe the data to be entered into the cells their respective columns.

Base form 413 is associated with content target 412 in that it may be generated from the information contained in the cells 405. For example, the labels of the various columns in the spreadsheet may correspond to the identity of control objects in base form 413. In other words, when generating base form 413, by way of a user instruction or an automated feature, the titles provided for each column may be used to identify the various control objects in base form 413. It should be understood that such a correspondence between the titles of columns and how control objects are identified is merely optional and provided for illustrative purposes only.

The control objects may be any type of object capable of accepting user input, such as a data entry field, a radio button object, a drop down menu, or the like. The user may select the control objects for inclusion in base form 413 through well-known development tools, such as object menus, drag and drop operations, and the like.

The identity of each field corresponds to the nature of the data that can be input into the control objects for delivery to and entry into the corresponding columns in content target 412. As illustrated, name data is entered into data entry field 414 and identifier (ID) information is entered into data entry field 415. Radio button object 416 allows the user to indicate yes or no regarding their planned attendance at the subject event. Menu object 417 allows the user to select their preferred style of meal: chicken (C), beef (B), or vegetarian (V). Similarly, menu object 418 allows the user to select their preferred topic of study at the subject event: mathematics (M), sports (S), or politics (P).

Graphics object 419 may contain or be linked to a script or other dynamic program module that may be called to enhance the presentation of a form derived from base form 413, which may occur in response to user inputs, programmed triggers, or any other type if event available within the execution environment of form 423 and form 433. For example, executable program code may be embedded in or linked to from within graphics object 419. Examples of executable code include hypertext markup language code or javascript code, although it should be understood that any number of suitable programing technologies may be employed to augment form 423 or form 433. Embedding or linking the executable code can be accomplished through any form development tool accessible through the spreadsheet represented by content targer 412 or within the productivity application hosting the spreadsheet.

Examples of functionality that could be provided by the executable code associated with graphics object 419 include monitoring events available from the environments within which forms derived from base form may be rendered. For example, events defined by user actions, such as hovering a mouse over a portion of a rendered form, clicking on objects within a rendered form, or inputting into a rendered form may be monitored by the code associated with graphics object 419. In response to any of these events, the executable code may be run, thereby augmenting the presentation of the rendered form. For example, the code may retrieve information, images, or other data from sources external to the rendered form for integration therein.

It should be understood that the executable code may also be capable of making calls to functions supported by content target 412. For instance, content target 412 may support certain queries or other similar calls initiated by the executable code that may reside in a rendered form. It should also be understood that the executable code need not be integrated or associated with a graphics object. Rather, base form 413 may include executable code that stands alone from any other objects contained therein. In this manner, forms rendered from base form 413 will have the executable code embedded therein and capable of augmenting the rendered forms.

Control information 408 contained within content target 412 controls some aspects of base form 413 and any forms derived from base form 413, such as form 423 and form 433. This may include controlling the format of data entered into a form, a range of values entered into a form, and the options from which a user may select values. For example, the format of data entered into data entry field 414, into which a name may be entered, is limited to character strings, while the format of data entered into data entry field 415 is limited to three digit strings. Radio button object 416 returns a value indicative of whether or not the person completing a rendered form intends to attend the subject event. For instance, radio button object 416 may return a binary numeric or text-based value to content target 412, or some other indication of attendance. Control of menu object 417 pertains to a group of data or values provided in menu object 417 from which a user may make a selection. In this example, C, B, or V may be selected. Similarly, control of menu object 418 pertains to a group of data or values—M, S, or P—from which a user may make a selection.

It should be noted that control information 408 may be changed by user input in several ways. First, in some cases the selection of some values through one form may change the available values from which other selections within that form or other forms may be made. In addition, a user operating content target 412 may make changes directly to control information 408. For example, a user may change the allowable format or data ranges for data entry fields 414 and 415. Similar, the user may change the data used to populate menu objects 417 and 418.

The changes noted above may be propagated to forms derived from base form 413 by way of the dynamic operations described herein. Namely, upon receiving user input, form 423 and form 433 communicate with content target 412 to identify the control information associated with the user input. In this manner, changes to content target 412 can dynamically drive changes in the appearance or behavior of forms 423 and 433. However, depending on the sequence in which form 423 and form 433 are opened relative to each other, the changes may also be propagated upon opening of either form. In other words, the changes may be propagated by way of modifying base form 413 such that forms that are rendered later contain the changes.

Referring now to FIG. 11, the following is a discussion of an example whereby two users interact with forms 423 and 433 to enter data into content target 412 to indicate their intentions to participate in the exemplary event mentioned above. Beginning with form 423, user 422 enters the name “Kristin” into data entry field 424. User 422 also enters the ID string “578” into data entry field 425 while also indicating via radio button object 426 that she will attend the subject event. User 422 selects vegetarian for her meal by way of menu object 427 and indicates politics as her topic of interest by way of menu object 428.

As user 422 interacts with form 423, a number of dynamic actions occur that enhance the user experience. As user 422 provides user input into data entry field 424 by typing her name, form 423 communicates with content target 412 to obtain the relevant control information for data entry field 424. This may involve content target 412 providing format instructions to form 423 against which the text provided by the user input can be evaluated. Alternatively, form 423 may provide the entered text to content target 412. Content target 412 may then evaluate the text against the format requirement and return an indication to forms 423 whether or not the text is accepted in view of the format requirement. In either case, user 422 may be informed by a graphic or some other indication if the entered text does not comply with the proper format. For exemplary purposes, it is assumed that user 422 has entered her name properly, which results in the string “Kristin” being communicated to content target 412 and entered in the spreadsheet under the name column.

Similar actions may occur with respect to data entry field 425 when user 422 enters an identifying string into data entry field 425. Control information may be returned to 423 describing the required format. In this case, it is assumed that the user input is entered successfully as a string of three digits and the numeric identifier “578” is transferred to content target 412 for entry in the spreadsheet under the ID column. An indication that user 422 will attend the subject event is also communicated to content target 412 and entered into the spreadsheet.

Turning to menu object 427, user 422 may first provide a selection of menu object 427. This initial selection can drive form 423 to communicate with content target 412 to obtain control information indicating possible values or a group of data with which to populate menu object 427. Optionally, menu object 427 may be populated upon form 423 being opened or otherwise initiated. Here, user 422 has selected vegetarian has her preferred meal, which is communicated to content target 412 and stored in the spreadsheet.

Finally, user 422 selects menu object 428, from which she can select a preferred topic. As with menu object 427, menu object 428 may be populated with options dynamically upon user 422 selecting it. However, menu object 427 may also be populated upon form 423 being opened or otherwise initiated, or populated in a dynamic manner at some other time. User 422 selects politics as her topic of interest and form 423 communicates this selection to content target 412. Content target 412 returns an instruction to form 423 to dynamically display via graphic object 429 a map relevant to her topic selection. In this example, the map pertains to an academic complex.

It should be understood that graphic object 429 may retrieve the map or other content independent from any instructions provided by content target 412. Rather, graphic object 429 may be programmed via code embedded in or linked to from form 423 to monitor the other control objects in form 423, such as menu object 428. Upon detecting specified triggers, graphic object 429, or the code associated with it, may be executed to obtain relevant graphics, such as the map of the academic complex. In other words, the dynamic augmentation of form 423 need not occur based on control information provided by content target 412.

However, the selection of politics by user 422 also drives a change in the control information pertaining to the topic column in content target 412. In this example, it is assumed for exemplary purposes that the selection of politics by user 422 causes a limitation upon possible topic selections by 432 to be enforced. As such, menu object 438 is limited to only the mathematics and sports topics. In other words, a selection by user 422 via form 423 dynamically changes the options presented to user 432 via form 433.

This dynamic change may occur in a number of ways. In one example, form 423 has communicated the selection by user 422 of politics to content target 412. Content target 412 may then automatically change the possible values associated with the topic column, eliminating P from the group of M, S, and P. In due course, form 433 would initiate a communication with content target 412 to obtain control information relevant to menu object 438, at which time content target 412 would supply the limited group of only M and S with which to populate menu object 438. In this way, user 432 is prevented from selecting politics as his topic of interest. It should be understood that form 433 may communicate with content target 412 to accomplish this, but may also communicate with base form 413. For instance, content target 412 may provide the control information to base form 413, thereby modifying base form 413. Then form 433 may communicate with base form 413 to obtain the control information with which form 433 is controlled.

Alternatively, menu object 438 may remain unchanged, but rather a filter may be applied by content target 412 against selections from menu object 438 provided by form 433. For example, user 433 may select politics as his topic of interest, which is then communicated by form 433 to content target 412. At that time, content target 412 may recognize that politics is no longer an allowed choice and responsively provide control information to form 433 indicating the rejection of politics as a selection by user 432.

In addition to the dynamic nature of menu object 428, graphics object 439 also behaves dynamically. Upon user 432 selecting sports as his topic of interest, form 433 communicates this selection to content target 412. Content target 412 returns an instruction to form 433 to dynamically display via graphic object 439 a map relevant to his topic selection. In this example, the map pertains to a sports complex.

It should be understood that graphic object 439 may retrieve the map or other content independent from any instructions provided by content target 412. Rather, graphic object 439 may be programmed via code embedded in or linked to from form 433 to monitor the other control objects in form 433, such as menu object 438. For example, graphics object 439 may contain or be linked to executable program code, such as hypertext markup language code or javascript code. Upon detecting specified triggers, graphic object 439, or the code associated with it, may be executed to obtain relevant graphics, such as the map of the academic complex. In other words, the dynamic augmentation of form 433 need not occur based on control information provided by content target 412.

Another example of dynamic form control is demonstrated by way of form 433 involving data entry field 435. In this example, user 432 has properly entered a character string of “John” into data entry field 434 and has indicated his intention to attend the subject event. Thus, “John” is communicated to content target 412 and entered into the spreadsheet along with an indication under attendance that he will attend the event. User 432 has also selected chicken as his preferred meal by way of menu object 437, which is communicated to content target 412.

However, user 432 has provided user input containing four digits into data entry field 435, contrary to the formatting required by content target 412 for data entered into the cells corresponding to the ID column via data entry field 435. As mentioned above, formatting of this type may be enforced in a number of ways, including communicating control information from content target 412 to form 433 that defines the format. Under these circumstances, form 433 can evaluate a string provided via user input and accept or reject the input data accordingly. Alternatively, form 433 may communicate the input data to content target 412. Content target 412 can then evaluate the input data independently against the formatting requirement and return an indication of acceptance or rejection to form 433. In this example, the four digit input provided by user 432 does not satisfy the format requirement and so a rejection is displayed to user 432.

Referring back to FIG. 6, computer system 600 includes processing system 601, storage system 603, communication interface 605, user interface 607, and software 608. User interface 607 may include a mouse, a voice input device, a touch input device, and other comparable input devices and associated processing elements capable of receiving user input from a user. Output devices such as a display, speakers, printer, and other types of output devices may also be included.

Processing system 601 is communicatively coupled with storage system 603. Storage system 603 stores software 608. Software 608 may include other applications, such as a productivity application, a browser application, an email application, or any other type of application. When executed by processing system 601, software 608 directs computer system 600 to operate as described herein for the elements of dynamic form element 400, such as computer system 411, computer system 421, and computer system 431.

Processing system 601 may comprise microprocessors and other circuitry that retrieve and execute software 608 from storage system 603. Processing system 601 may be implemented within a single processing device but may also be distributed across multiple processing devices or sub-systems that cooperate in executing program instructions. Examples of processing system 601 include general purpose central processing units, application specific processors, and logic devices, as well as any other type of processing device.

Storage system 603 may comprise any storage media readable by processing system 601 and capable of storing software 608. Storage system 603 may include volatile and nonvolatile, removable and non-removable media implemented in any method or technology for storage of information, such as computer readable instructions, data structures, program modules, or other data. Storage system 603 may be implemented as a single storage device but may also be implemented across multiple storage devices or sub-systems. Storage system 603 may comprise additional elements, such as controllers, capable of communicating with processing system 601.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 608 comprises computer program instructions, firmware, or some other form of machine-readable processing instructions. Software 608 may be implemented as a single application but also as multiple applications, or integrated together. In general, software 608, when loaded into processing system 601, transforms computer system 600 from a general-purpose computing system into a special-purpose computing system customized to operate as described for the elements of dynamic for environment 400, including computer system 411, computer system 421, and computer system 431 operating content target 412, base form 413, form 423, and form 433 respectively.

Communication interface 605 may include communication connections and devices that allow for communication between computer system 600 and other computer systems over communication network 401. Examples of connections and devices that together allow for inter-system communication include network interface cards, antennas, power amplifiers, RF circuitry, transceivers, and other communication circuitry. The aforementioned network, connections, and devices are well known in the art and need not be discussed at length here.

It may be appreciated that the implementations disclosed herein provide the ability to automatically validate data entry of form fields on a spreadsheet based form. In addition, the implementations disclosed herein provide the ability to control and populate form specifics automatically based on data from within a spreadsheet. This may include the ability to make a form entry field a drop down box containing valid possibilities, and having those possibilities populated from spreadsheet based validation.

Another example may involve having the spreadsheet based validation be dynamic. As data is entered in a spreadsheet through the spreadsheet itself or by way of other mechanisms, such as a form, then users who visit the form in the future will have their valid answers change based on the data that has already been entered.

It may also be appreciated that implementations disclosed herein provide the ability to extend a spreadsheet-based form using programmability mechanisms. For example, form-owners may have the ability to write javascript code that references form questions, form fields, and other form aspects to customize the user experience in real time while the user is filling out the form.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for providing forms linked to content targets within productivity applications, the method comprising:
generating within a content target hosted by a productivity application a base form comprising a plurality of base components;
rendering external to the content target a user form comprising a plurality of user components corresponding to the plurality of base components; and
dynamically controlling the user form based on a plurality of events corresponding to the plurality of user components.

2. The method of claim 1 wherein the plurality of events comprises user input and wherein dynamically controlling the user form based on the plurality of events comprises validating the user input based on control information within the content target.

3. The method of claim 2 wherein the control information indicates at least a valid format or a valid range for input data entered into the user form via the user input through at least one of the plurality of user components.

4. The method of claim 1 wherein at least one of the plurality of events comprises user input and wherein dynamically controlling the user form comprises modifying a group of values selectable from at least one of the plurality of user components based on the user input.

5. The method of claim 1 wherein dynamically controlling the user form comprises running executable code embedded within the user form in response to at least one of the plurality of events to augment display of the user form.

6. The method of claim 1 wherein dynamically controlling the user form comprises running executable code linked to from within the user form in response to at least one of the plurality of events to augment display of the user form.

7. The method of claim 1 wherein the content target comprises one of at least a spreadsheet editable by a spreadsheet application or a document editable by a document editor, and wherein the productivity application comprises one of at least the spreadsheet application or the document editor.

8. One or more computer readable media having program instructions stored thereon for providing forms linked to content targets within productivity applications, that when executed by a dynamic form system, direct the dynamic form system to:
generate within a content target hosted by a productivity application a base form comprising a plurality of base components;
render external to the content target a user form comprising a plurality of user components corresponding to the plurality of base components; and
dynamically control the user form based on a plurality of events corresponding to the plurality of user components.

9. The one or more computer readable media of claim 8 wherein the plurality of events comprises user input and wherein to dynamically control the user form based on the plurality of events the dynamic form system is further directed by the program instructions to validate the user input based on control information within the content target.

10. The one or more computer readable media of claim 9 wherein the control information indicates at least a valid format or a valid range for input data entered into the user form via the user input through at least one of the plurality of user components.

11. The one or more computer readable media of claim 8 wherein at least one of the events comprises user input and wherein to dynamically control the user form the dynamic form system is directed by the program instructions to modify a group of values selectable from at least one of the plurality of user components based on the user input.

12. The one or more computer readable media of claim 8 wherein to dynamically control the user form the dynamic form system is directed by the program instructions to run executable code embedded within the user form to augment display of the user form in response to at least one of the plurality of events.

13. The one or more computer readable media of claim 8 wherein to dynamically control the user form the dynamic form system is directed by the program instructions to run executable code linked to from within the user form to augment display of the user form in response to at least one of the plurality of events.

14. The one or more computer readable media of claim 8 wherein the content target comprises one of at least a spreadsheet editable by a spreadsheet application or a document editable by a document editor, and wherein the productivity application comprises one of at least the spreadsheet application or the document editor.

15. One or more computer readable media having stored thereon program instructions for operating forms linked to content targets within productivity applications, that when executed by a computer system, direct the computer system to:
receive user input in a form derived from a base form associated with a content target;
identify control information within the content target;
control the form in response to the user input based on the control information identified within the content target.

16. The one or more computer readable media of claim 15 wherein the control information identifies a valid format for data entered into the content target, wherein the user input comprises input data, and wherein to control the form in response to the user input, the program instructions direct the computer system to accept or reject the input data for delivery to and entry in the content target depending on whether or not the input data is formatted in accordance with the valid format.

17. The one or more computer readable media of claim 15 wherein the control information identifies a valid group of data to enter into the content target, wherein the user input comprises a selection of an input graphic within the form, and wherein to control the form in response to the user input, the program instructions direct the computer system to populate the input graphic with the valid group of data.

18. The one or more computer readable media of claim 15 wherein the control information identifies a program module that resides within the form and that drives a display of the form, wherein the user input comprises input data, and wherein to control the form in response to the user input, the program instructions direct the computer system to call the program module to drive the display of the form based on the input data.

19. The one or more computer readable media of claim 15 wherein, to identify the control information within the content target, the program instructions direct the computer system to generate and transfer, for delivery from the form to the content target over a communication network, a request for the control information.

20. The one or more computer readable media of claim 15 wherein the content target comprises one of at least a spreadsheet editable by a spreadsheet application or a document editable by a document editor.
